(19) United States
(12) Patent Application Publication
(10) Pub. No.: US 2024/0354449 A1
(43) Pub. Date: Oct. 24, 2024

(54) GLITCH DETECTOR AND GLITCH DETECTION METHOD USING THE SAME

(71) Applicant: SAMSUNG ELECTRONICS CO., LTD., Suwon-si (KR)

(72) Inventor: Donghun Heo, Suwon-si (KR)

(73) Assignee: SAMSUNG ELECTRONICS CO., LTD., Suwon-si (KR)

(21) Appl. No.: 18/413,852

(22) Filed: Jan. 16, 2024

(30) Foreign Application Priority Data
Apr. 24, 2023 (KR) 10-2023-0053454
Jun. 23, 2023 (KR) 10-2023-0081174

(51) Int. Cl. G06F 21/81; G06F 21/78

(52) U.S. Cl. CPC G06F 21/81; G06F 21/78

(57) ABSTRACT

A glitch detector, a glitch detection method, and a security device including the glitch detector. The glitch detector includes: a sensing unit configured to generate a glitch voltage and at least one reference voltage based on a power supply voltage; a clock generator configured to receive a monitoring voltage corresponding to at least one from among the power supply voltage and the glitch voltage, and to output a clock signal including a plurality of pulse signals while a voltage change occurs in the monitoring voltage, wherein the plurality of pulse signals have a predetermined period; and a comparison unit configured to operate based on each of the plurality of pulse signals, and to compare the glitch voltage with the at least one reference voltage and output a detection voltage based on determining that a glitch has occurred.

### CROSS-REFERENCE TO RELATED APPLICATION(S)

This application is based on and claims priority under 35 USC § 119 to Korean Patent Application Nos. 10-2023-0053454, filed on Apr. 24, 2023 and 10-2023-0081174, filed on Jun. 23, 2023, in the Korean Intellectual Property Office, the disclosures of which are incorporated by reference herein in their entirety.

### BACKGROUND

### 1. Field

The disclosure relates to a glitch detector, a security device, and a glitch detection method.

### 2. Description of Related Art

Security devices may be used for processing and/or storing secure data. Data stored in such security devices should be retained securely and safely. However, the stored data may be significantly vulnerable to an attacker when the data is leaked to the outside.

For example, when an attacker directly monitors signals in the security device to ascertain data stored therein, the monitored data may be fatally damaged, for example by being leaked to the attacker.

Therefore, the security device may include detectors which may be used to detect abnormal conditions, for example, abnormal voltage, frequency, temperature, glitches, light exposure, or the like. For example, the security device may include a glitch detector.

The glitch detector may be used to detect the abnormal conditions, and may not affect an operation of the security device under normal conditions.

### SUMMARY

Provided is a glitch detector configured to detect a glitch in response to clock signals continuously generated while the glitch occurs in a power supply voltage.

Additional aspects will be set forth in part in the description which follows and, in part, will be apparent from the description, or may be learned by practice of the presented embodiments.

In accordance with an aspect of the disclosure, a glitch detector includes: a sensing unit configured to generate a glitch voltage and at least one reference voltage based on a power supply voltage; a clock generator configured to receive a monitoring voltage corresponding to at least one from among the power supply voltage and the glitch voltage, and to output a clock signal including a plurality of pulse signals while a voltage change occurs in the monitoring voltage, wherein the plurality of pulse signals have a predetermined period; and a comparison unit configured to operate based on each of the plurality of pulse signals, and to compare the glitch voltage with the at least one reference voltage and output a detection voltage based on determining that a glitch has occurred.

In accordance with an aspect of the disclosure, a glitch detection method includes generating, using a sensing unit, a glitch voltage and at least one reference voltage based on a power supply voltage; outputting, using a clock generator, a clock signal including a plurality of pulse signals while a voltage change occurs in a monitoring voltage corresponding to at least one from among the power supply voltage or the glitch voltage, wherein the plurality of pulse signals have a predetermined period; comparing, suing a comparison unit, the glitch voltage with the at least one reference voltage based on each of the plurality of pulse signals; and outputting a detection voltage based on determining that a glitch has occurred in the power supply voltage, based on a result of the comparison.

In accordance with an aspect of the disclosure, a security device includes: a security memory configured to store secure data; a security processor configured to process the secure data and reset based on a reset signal; a glitch detector configured to generate at least one detection voltage in response to a glitch occurring in a power supply voltage; and a reset signal generator configured to generate the reset signal based on the at least one detection voltage, wherein the glitch detector includes: a sensing unit configured to generate a glitch voltage and at least one reference voltage based on the power supply voltage; a clock generator configured to receive a monitoring voltage corresponding to at least one from among the power supply voltage and the glitch voltage, and to output a clock signal including a plurality of pulse signals while a voltage change occurs in the monitoring voltage, wherein the plurality of pulse signals have a predetermined period; and a comparison unit configured to operate based on each of the plurality of pulse signals and to compare the glitch voltage with the at least one reference voltage and output a detection voltage based on determining that the glitch has occurred.

### BRIEF DESCRIPTION OF DRAWINGS

The above and other aspects, features, and advantages of the present disclosure will be more apparent from the following detailed description taken in conjunction with the accompanying drawings, in which:

FIG. 1 is a block diagram of a glitch detector according to an embodiment;

FIG. 2 is a circuit diagram illustrating an example of a glitch detector according to an embodiment;

FIG. 3A is a block diagram illustrating an example of a clock generator in the glitch detector of FIG. 2, according to an embodiment;

FIG. 3B is a circuit diagram illustrating an example of a pulse generator of FIG. 3A, according to an embodiment;

FIG. 3C is a timing diagram illustrating an operation of a first pulse generator of FIG. 3A, according to an embodiment;

FIG. 4A is a circuit diagram illustrating an example of an oscillator of FIG. 3A, according to an embodiment;

FIG. 4B is a timing diagram illustrating the operation of the oscillator of FIG. 4A, according to an embodiment;

FIG. 5 is a circuit diagram illustrating an example of a first comparator of FIG. 2, according to an embodiment;

FIG. 6 is a timing diagram illustrating an operation of the first comparator of FIG. 5, according to an embodiment;

FIG. 7 is a circuit diagram of a glitch detector according to an embodiment;

FIG. 8 is a circuit diagram illustrating a portion of a clock generator in the glitch detector of FIG. 7, according to an embodiment;

FIG. 9 is a timing diagram illustrating an operation of the glitch detector of FIG. 7, according to an embodiment;

FIG. 10 is a flowchart illustrating a glitch detection method according to an embodiment;

FIG. 11 is a block diagram illustrating a security device according to an embodiment;

FIG. 12 is a flowchart illustrating a method of operating the security device of FIG. 11, according to an embodiment.

### DETAILED DESCRIPTION

Hereinafter, example embodiments will be described with reference to the accompanying drawings.

As is traditional in the field, embodiments may be described and illustrated in terms of blocks which carry out a described function or functions. These blocks, which may be referred to herein as units modules or the like, or by names such as generator, oscillator, detector, or the like, may be physically implemented by analog or digital circuits such as logic gates, integrated circuits, microprocessors, microcontrollers, memory circuits, passive electronic components, active electronic components, optical components, hardwired circuits, or the like, and may be driven by firmware and software. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

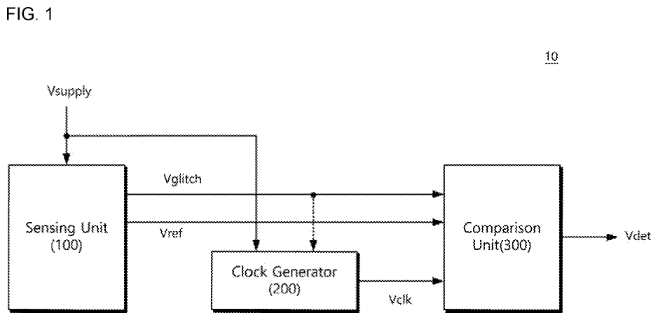

FIG. 1 is a block diagram of a glitch detector according to an example embodiment.

Referring to FIG. 1, a glitch detector 10 according to an example embodiment may include a sensing unit 100, a clock generator 200, and a comparison unit 300.

The sensing unit 100 may generate a glitch voltage Vglitch and at least one reference voltage Vref based on a power supply voltage Vsupply.

The power supply voltage Vsupply may be a voltage used to drive any electronic device and/or system including the glitch detector 10. For example, the power voltage Vsupply may be an analog power supply voltage, but example embodiments are not limited thereto.

For example, the sensing unit 100 may generate a glitch voltage Vglitch corresponding to at least a portion of the power supply voltage Vsupply. As an example, the glitch voltage Vglitch may have substantially the same waveform as the power supply voltage Vsupply. As another example, the glitch voltage Vglitch may refer to a voltage, including a voltage at a time point at which a glitch (or a voltage change) occurs within the power supply voltage Vsupply.

A glitch may refer to a voltage change occurring in a power supply voltage for a relatively small amount of time due to, for example, a temporary malfunction of an electronic device or system, or due to an external security attack.

The sensing unit 100 may generate at least one reference voltage Vref from or based on the power supply voltage Vsupply. The at least one reference voltage Vref may be a voltage signal corresponding to a partial frequency band of the power supply voltage Vsupply. For example, the at least one reference voltage Vref may be generated by applying a filter which passes a signal having a specified frequency band to the power supply voltage Vsupply.

For example, the at least one reference voltage Vref may include a first reference voltage and a second reference voltage lower than the first reference voltage, but example embodiments are not limited thereto.

The clock generator 200 may output a clock signal Vclk including a plurality of pulse signals while a voltage change occurs in the power supply voltage Vsupply or the glitch voltage Vglitch.

For example, the clock generator 200 may receive a monitoring voltage corresponding to one of the power supply voltage Vsupply and the glitch voltage Vglitch. The clock generator 200 may output a clock signal Vclk including a plurality of pulse signals while a voltage change (or, for example, a glitch) occurs in the monitoring voltage.

The clock generator 200 may continuously output a plurality of pulse signals according to a predetermined cycle while a voltage change occurs in the monitoring voltage.

For example, the clock generator 200 may be a circuit configured to convert a glitch occurring in the power supply voltage Vsupply into a clock signal Vclk, and to output the converted clock signal Vclk. Accordingly, the clock generator 200 may be referred to as a “glitch-to-clock circuit.”

The comparison unit 300 may output a detection voltage Vdet depending on whether a glitch has occurred, in response to each of the plurality of pulse signals included in the clock signal Vclk.

For example, the comparison unit 300 may compare the glitch voltage Vglitch with at least one reference voltage Vref in response to each of the plurality of pulse signals included in the clock signal Vclk. Also, the comparison unit 300 may determine whether a glitch has occurred in the power supply voltage Vsupply, based on a result of the comparison.

As an example, when the glitch voltage Vglitch is greater than the first reference voltage, the comparison unit 300 may determine that an up-glitch, which may be referred to as a positive glitch, has occurred in the power supply voltage Vsupply.

As another example, when the glitch voltage Vglitch is less than the second reference voltage lower than the first reference voltage, the comparison unit 300 may determine that a down-glitch, which may be referred to as a negative glitch, has occurred.

The comparison unit 300 may output the detection voltage Vdet based on determining that a glitch has occurred.

For example, the comparison unit 300 may be implemented to include a latch-type comparator. However, the configuration of the comparison unit 300 is not limited to the above-described example, and may be including various configurations for comparing the glitch voltage Vglitch and the at least one reference voltage Vref.

The comparison unit 300 may operate at a time point at which each of the plurality of pulse signals included in the clock signal is generated. For example, the comparison unit 300 may not operate at a time point at which a clock signal is not generated.

Accordingly, the glitch detector 10 may significantly reduce power, consumed by the comparison unit 300, during a normal operation in which a voltage change (or a glitch) does not occur in the power supply voltage Vsupply.

As described above, the glitch detector 10 may determine whether a glitch has occurred in response to or based on a clock signal which is generated while a voltage change occurs in the power supply voltage Vsupply.

For example, the glitch detector 10 may detect whether a glitch has occurred, based on a clock signal including a plurality of pulse signals which are continuously generated according to a predetermined period while a voltage change occurs in the power supply voltage.

In this way, the glitch detector 10 may detect whether a glitch has occurred, without being affected by one or more factors such as a glitch occurrence speed, for example, a rising time or a falling time, and a glitch pulse width.

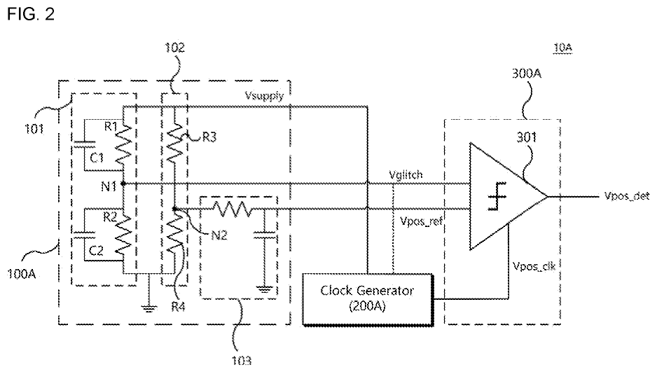

FIG. 2 is a circuit diagram illustrating an example of a glitch detector according to an example embodiment.

Referring to FIG. 2, a glitch detector 10A may detect that a glitch has occurred in a power supply voltage Vsupply, in response to a first clock signal Vpos_clk generated by a clock generator 200A. In this case, the glitch detector 10A of FIG. 2 may be corresponding to, for example, the glitch detector 10 of FIG. 1. For example, in some embodiments, the first clock signal Vpos_clk may correspond to the clock signal Vclk.

A sensing unit 100A may include a first circuit 101 configured to generate a glitch voltage Vglitch, a second circuit 102 configured to generate at least one reference voltage Vref, and a first low pass filter (LPF) 103 connected to the second circuit 102. In embodiments, the LPF 103 may include at least one of a resistor and a capacitor as shown in FIG. 2, but embodiments are not limited thereto.

According to an example embodiment, the first circuit 101 may include a first resistor R1 and a first capacitor C1 connected in parallel between a first node N1, from which a glitch voltage Vglitch is output, and a power supply voltage Vsupply. Also, the first circuit 101 may include a second resistor R2 and a second capacitor C2 connected in parallel between the first node N1 and a ground voltage, which may be referred to as a ground. In embodiments, the power supply voltage Vsupply may be supplied using a power supply voltage node, and the ground voltage may be supplied using a ground node.

The above-described configuration may allow the first circuit 101 to generate a glitch voltage Vglitch having substantially the same waveform as at least a portion of the power supply voltage Vsupply.

According to an example embodiment, the second circuit 102 may include a third resistor R3 and a fourth resistor R4 connected in series between the power supply voltage Vsupply and the ground. In this way, the second circuit 102 may generate at least one reference voltage Vref based on the power supply voltage Vsupply.

For example, the sensing unit 100A may generate a first reference voltage Vpos_ref by applying a first low pass filter 103 to a signal output from a second node N2 between the third resistor R3 and the fourth resistor R4. A voltage level of the first reference voltage Vpos_ref may be determined based on resistance values of the third and fourth resistors R3 and R4.

The clock generator 200A may receive the power supply voltage Vsupply or the glitch voltage Vglitch, and may output the first clock signal Vpos_clk.

For example, the clock generator 200A may output the first clock signal Vpos_clk during a voltage change in response to the voltage change occurring in one of the power supply voltage Vsupply and the glitch voltage Vglitch.

In this case, the first clock signal Vpos_clk may include a plurality of pulse signals continuously generated according to a predetermined period while a positive voltage change occurs in one of the power supply voltage Vsupply and the glitch voltage Vglitch.

The comparison unit 300A may include a first comparator 301 configured to compare the glitch voltage Vglitch with the first reference voltage Vpos_ref in response to or based on the first clock signal Vpos_clk generated by the clock generator 200A.

The first comparator 301 may compare the glitch voltage Vglitch with the first reference voltage Vpos_ref in response to each of the plurality of pulse signals included in the first clock signal Vpos_clk. In addition, the first comparator 301 may generate a first detection voltage Vpos_det based on a result of the comparison.

As an example, when the glitch voltage Vglitch is greater than the first reference voltage Vpos_ref, the first comparator 301 may determine that an up-glitch has occurred in the power supply voltage Vsupply. Accordingly, the first comparator 301 may generate the first detection voltage Vpos_det.

As another example, the glitch detector 10A may compare the glitch voltage Vglitch with a second reference voltage lower than the first reference voltage Vpos_ref. In addition, the glitch detector 10A may determine that a down-glitch has occurred in the power supply voltage Vsupply when the glitch voltage Vglitch is less than the second reference voltage. Accordingly, the glitch detector 10A may generate the second detection voltage.

As described above, the glitch detector 10A may determine whether a glitch has occurred, in response to a plurality of pulse signals continuously generated while a voltage change occurs in the power supply voltage Vsupply.

In this way, the glitch detector 10A may detect whether a glitch has occurred in the power supply voltage Vsupply without being affected by a glitch occurrence speed, a glitch occurrence period, and/or a glitch pulse width.

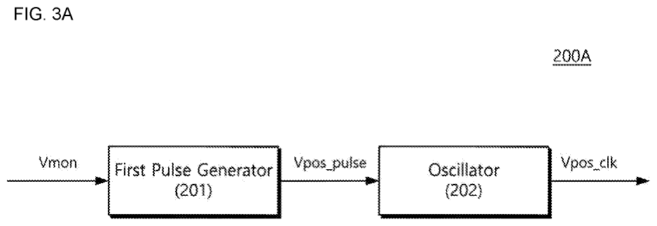

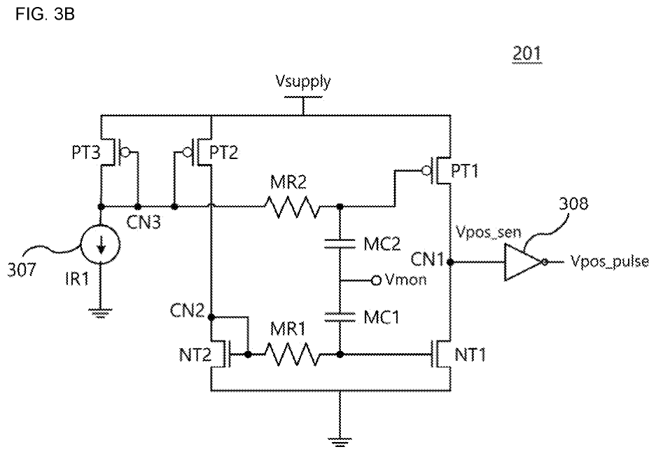

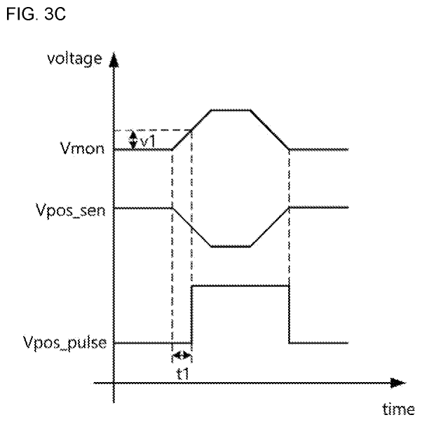

FIG. 3A is a block diagram illustrating an example of a clock generator 200A of the glitch detector of FIG. 2. FIG. 3B is a circuit diagram illustrating an example of the pulse generator of FIG. 3A. FIG. 3C is a timing diagram illustrating an operation of the first pulse generator 201 of FIG. 3A.

Referring to FIG. 3A, a clock generator 200A according to an example embodiment may include a first pulse generator 201 and an oscillator 202.

The first pulse generator 201 according to an example embodiment may receive a monitoring voltage Vmon to generate a first pulse voltage Vpos_pulse.

For example, the clock generator 200A may include a first pulse generator 201 generating a first pulse voltage Vpos_pulse while a voltage change (or a glitch) occurs in the monitoring voltage Vmon.

The monitoring voltage Vmon may be a voltage corresponding to at least a portion of the power supply voltage Vsupply or the glitch voltage Vglitch.

The oscillator 202 according to an example embodiment may generate a first clock signal Vpos_clk, including a plurality of pulse signals, while the first pulse voltage Vpos_pulse is maintained.

Referring to FIG. 3B, the first pulse generator 201 may include PMOS transistors PT1, PT2, and PT3, a current source 307, NMOS transistors NT1 and NT2, a first inverter 308, monitoring resistors MR1 and MR2, and monitoring capacitors MC1 and MC2. The first pulse generator 201 may be driven by a power supply voltage Vsupply. For example, the power supply voltage Vsupply may be referred to as a digital power supply voltage.

For example, the first pulse generator 201 may include a first PMOS transistor PT1 connected to a first clock node CN1, from which the first pulse voltage Vpos_pulse is output, and the power supply voltage Vsupply. Also, the first pulse generator 201 may include a first NMOS transistor NT1 connected between the first clock node CN1 and a ground. Also, the first pulse generator 201 may include a second NMOS transistor NT2 connected between a second clock node CN2 and the ground. The second NMOS transistor NT2 may include a gate electrode connected to the second clock node CN2.

The first pulse generator 201 may include a first monitoring resistor MR1 connected between the second clock node CN2 and the gate electrode of the first NMOS transistor NT1. Also, the first pulse generator 201 may include a second monitoring resistor MR2 connected to a gate electrode of the first PMOS transistor PT1.

The first pulse generator 201 may include a first monitoring capacitor MC1 connected between the monitoring voltage Vmon and a gate electrode of the first NMOS transistor NT1. The first pulse generator 201 may further include a second monitoring capacitor MC2 connected between the monitoring voltage Vmon and the gate electrode of the first PMOS transistor PT1.

Referring to FIGS. 3A, 3B, and 3C together, according to an example embodiment, the first PMOS transistor PT1 may be turned on during a normal operation in which a glitch does not occur in the monitoring voltage Vmon, and thus current may flow from the power supply voltage Vsupply to the first clock node CN1. In this case, the first NMOS transistor NT1 may be in a turned-off state.

Accordingly, a first sensing voltage Vpos_sen at the first clock node CN1 may be substantially the same as the power supply voltage Vsupply.

In this case, current flowing through the third PMOS transistor PT3 may be substantially the same as first reference current IR1 of the current source 307. In addition, current flowing through the second PMOS transistor PT2 and current flowing through the second NMOS transistor NT2 may also be substantially the same as the first reference current IR1 of the current source 307.

According to an example embodiment, when a voltage change occurs in the monitoring voltage Vmon, a voltage applied to a gate electrode of the first NMOS transistor NT1 may be instantaneously increased by the first monitoring capacitor MC1 and the first monitoring resistor MR1. Thus, the first NMOS transistor NT1 may be turned on.

In addition, a voltage applied to a gate electrode of the first PMOS transistor PT1 may be instantaneously decreased by the second monitoring capacitor MC2 and the second monitoring resistor MR2. Thus, the first PMOS transistor PT1 may be turned off.

In this case, current may flow from the first clock node CN1 through the first NMOS transistor NT1 to the ground. Accordingly, the first sensing voltage Vpos_sen at the first clock node CN1 may be substantially the same as a ground voltage (for example, 0V).

The first pulse generator 201 may further include a first inverter 308 connected to the first clock node CN1.

The first pulse voltage Vpos_pulse may be generated when the first sensing voltage Vpos_sen at the first clock node CN1 passes through the first inverter 308.

For example, when the first sensing voltage Vpos_sen at the first clock node CN1 is substantially the same as the power supply voltage Vsupply, the first pulse voltage Vpos_pulse may have a value of “0.” When the first sensing voltage Vpos_sen at the first clock node CN1 is substantially the same as the ground voltage, the first pulse voltage Vpos_pulse may have a value of “1.”

However, the value of the first pulse voltage Vpos_pulse is not limited to the above examples, and the first pulse voltage Vpos_pulse may have various values indicating a state in which a voltage change occurs in the monitoring voltage Vmon.

The first pulse generator 201 may turn on, or activate, the first NMOS transistor NT1 and turn off, or deactivate, the first PMOS transistor PT1 in response to the voltage change occurring in the monitoring voltage Vmon.

Accordingly, the first sensing voltage Vpos_sen at the first clock node CN1 may be converted from the power supply voltage Vsupply to the ground voltage. In addition, the first pulse voltage Vpos_pulse may be output based on a change in the first sensing voltage Vpos_sen at the first clock node CN1. However, the first pulse voltage Vpos_pulse may be generated after a delay time t1 required to generate a constant voltage change v1 in the monitoring voltage Vmon.

Referring to the above-described configurations, the first pulse generator 201 may turn off the first PMOS transistor when a voltage change (or a glitch) occurs in the monitoring voltage Vmon. In this way, the first pulse generator 201 may significantly reduce an effect of noise or fluctuation occurring in the power supply voltage Vsupply.

For example, even when noise or fluctuation occurs in the power supply voltage Vsupply, the first pulse generator 201 may detect a change in the monitoring voltage Vmon to output the first pulse voltage Vpos_pulse.

Accordingly, the glitch detector 10A may improve stability of the operation of the first pulse generator 201 outputting the first pulse voltage Vpos_pulse based on the change in the monitoring voltage Vmon.

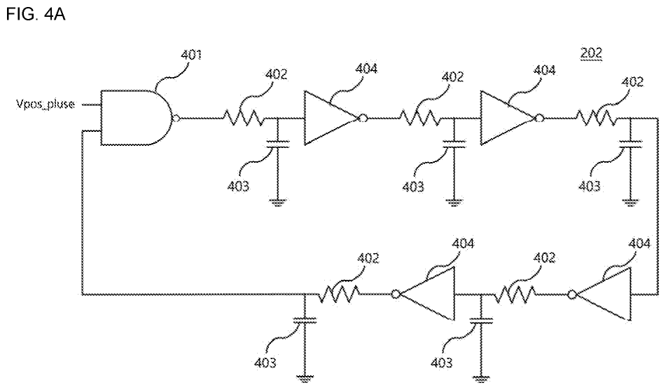

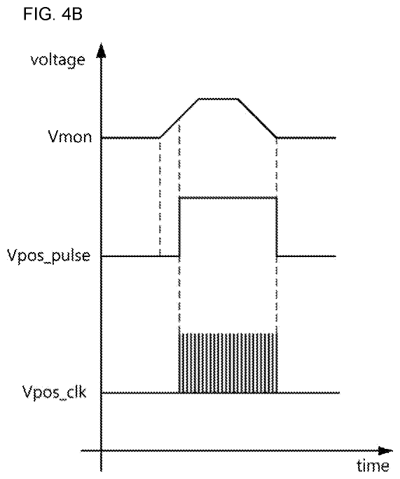

FIG. 4A is a circuit diagram illustrating an example of an oscillator of FIG. 3A. FIG. 4B is a timing diagram illustrating the operation of the oscillator of FIG. 4A.

Referring to FIGS. 4A and 4B together, the oscillator 202 according to an example embodiment may generate a first clock signal Vpos_clk including a plurality of pulse signals generated while a first pulse voltage Vpos_pulse is generated.

For example, the oscillator 202 may receive the first pulse voltage Vpos_pulse, and may continuously generate a plurality of pulse signals according to a predetermined period while the first pulse voltage Vpos_pulse is generated.

According to an example embodiment, the oscillator 202 may include an oscillation circuit including a NAND gate 401, a plurality of resistors 402, a plurality of capacitors 403, and a plurality of amplifiers, which may be for example inverters 404. For example, the oscillator 202 may generate a plurality of pulse signals according to a predetermined period using a feedback structure through the plurality of amplifiers, resistors, and capacitors while the first pulse voltage Vpos_pulse is maintained.

According to an example embodiment, the oscillator 202 may include a control circuit connected to an external clock generator. For example, the oscillator 202 may receive an external clock signal, generated according to a predetermined period, from an external clock generator. Also, the oscillator 202 may output external clock signals, received while the first pulse voltage Vpos_pulse is maintained, among the received external clock signals. In this case, the output external clock signals may be referred to as the first clock signal Vpos_clk output from the clock generator 200A.

However, the configuration and type of the oscillator 202 are not limited to the above examples, and the oscillator 202 may be understood to have various configurations and types for generating the first clock signal Vpos_clk including a plurality of pulse signals based on the first pulse voltage Vpos_pulse.

Referring to the above-described configuration, the glitch detector 10A may continuously output a plurality of pulse signals according to a predetermined period while the first pulse voltage Vpos_pulse is maintained.

Also, the glitch detector 10A may detect whether a glitch has occurred in response to each of the plurality of pulse signals.

In this way, the glitch detector 10A may detect whether a glitch has occurred in a power supply voltage Vsupply without being affected by the glitch occurrence speed, a glitch occurrence period, and/or a glitch pulse width.

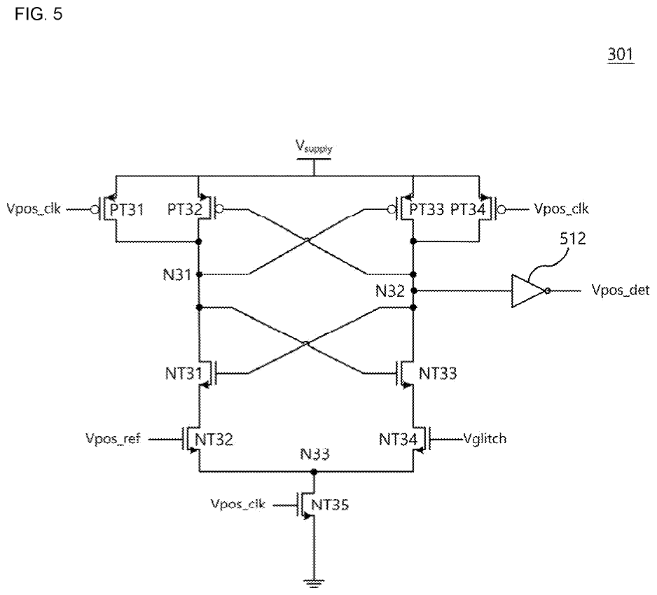

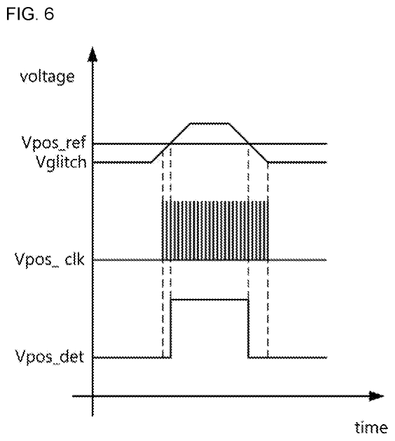

FIG. 5 is a circuit diagram illustrating an example of the first comparator 301 of FIG. 2. FIG. 6 is a timing diagram illustrating an operation of the first comparator 301 of FIG. 5.

Referring to FIG. 5, the first comparator 301 may include a plurality of PMOS transistors PT31, PT32, PT33, and PT34, a plurality of NMOS transistors NT31, NT32, NT33, NT34, and NT35, and a comparator inverter 512.

A first comparison PMOS transistor PT31 and a second comparison PMOS transistor PT32 may be connected in parallel between the power supply voltage Vsupply and a first comparison node N31. A gate electrode of the first comparison PMOS transistor PT31 may receive the first clock signal Vpos_clk as shown in FIG. 5, and a gate electrode of the second comparison PMOS transistor PT32 may be connected to a second comparison node N32. A third comparison PMOS transistor PT33 and a fourth comparison PMOS transistor PT34 may be connected in parallel between the power supply voltage Vsupply and the second comparison node N32. A gate electrode of the third comparison PMOS transistor PT33 may be connected to the first comparison node N31, and a gate electrode of the fourth comparison PMOS transistor PT34 may receive the first clock signal Vpos_clk.

A first comparison NMOS transistor NT31 and a second comparison NMOS transistor NT32 may be connected in series between the first comparison node N31 and a third comparison node N33. A gate electrode of the first comparison NMOS transistor NT31 may be connected to the second comparison node N32, and a gate electrode of the second comparison NMOS transistor NT32 may receive a first reference voltage Vpos_ref A third comparison NMOS transistor NT33 and a fourth comparison NMOS transistor NT34 may be connected in series between the second comparison node N32 and the third comparison node N33. A gate electrode of the third comparison NMOS transistor NT33 may be connected to the first comparison node N31, and a gate electrode of the fourth comparison NMOS transistor NT34 may receive a glitch voltage Vglitch. A fifth comparison NMOS transistor NT35 may be connected between the third comparison node N33 and a ground, and may include a gate electrode receiving the first clock signal Vpos_clk.

The comparator inverter may invert a voltage output from the second comparison node N32 to generate the first detection voltage Vpos_det.

Referring to FIGS. 5 and 6 together, the first comparator 301 may compare the glitch voltage Vglitch with the first reference voltage Vpos_ref in response to the input first clock signal Vpos_clk through the above-described configuration.

For example, when the glitch voltage Vglitch is greater than the first reference voltage Vpos_ref, the first comparator 301 may output the first detection voltage Vpos_det in response to each of the plurality of pulse signals included in the first clock signal Vpos_clk.

The structure of the first comparator 301 may be understood as, for example, a latch-type comparator. However, the structure of the first comparator 301 is not limited to the above example.

The first comparator 301 may have various structures for comparing the glitch voltage Vglitch and the first reference voltage Vpos_ref in response to the first clock signal Vpos_clk to output the first detection voltage Vpos_det.

As described above, the first comparator 301 may not operate in a state in which the first clock signal Vpos_clk is not input.

In this way, the glitch detector 10A may significantly reduce power consumed by the comparison unit 300A during a normal operation in which a voltage change (or a glitch) does not occur in the power supply voltage Vsupply.

Although FIGS. 5 and 6 illustrate the first clock signal Vpos_clk being used, in embodiments other clock signals may be used, for example the clock signal Vclk and any signal included in the clock signal Vclk.

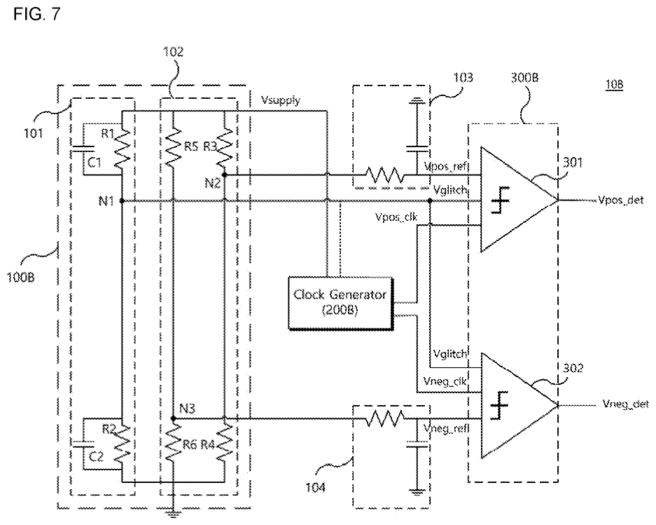

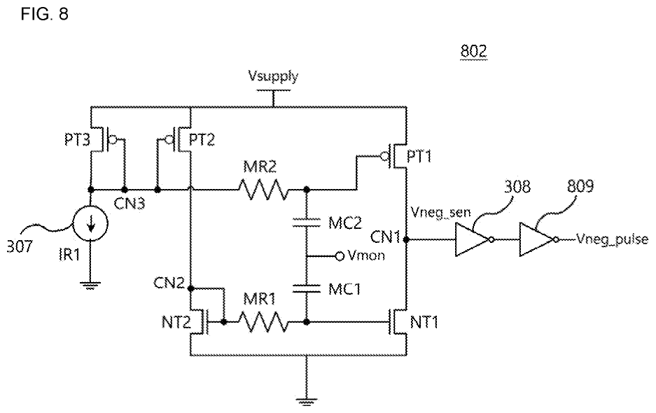

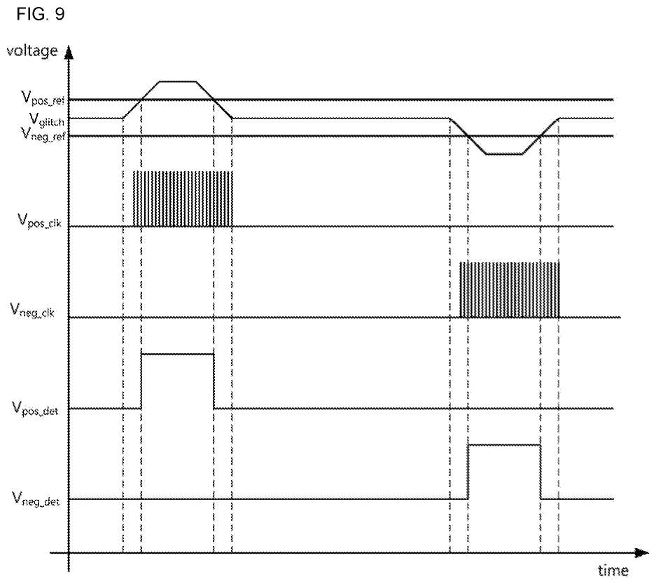

FIG. 7 is a circuit diagram illustrating a glitch detector 10B according to an example embodiment. FIG. 8 is a circuit diagram illustrating a portion of the clock generator 200B in the glitch detector of FIG. 7. FIG. 9 is a timing diagram illustrating an operation of the glitch detector of FIG. 7.

Referring to FIG. 7, the glitch detector 10B according to an example embodiment may include a sensing unit 100B, a clock generator 200B, and a comparison unit 300B.

The glitch detector 10B illustrated in FIG. 7 may include at least a portion of the components of the glitch detector 10A illustrated in FIG. 2. Therefore, the same or substantially the same components as those described above are denoted by the same reference numerals, and detailed descriptions thereof may be omitted.

According to an example embodiment, the glitch detector 10B may include a sensing unit 100B configured to generate a glitch voltage Vglitch, a first reference voltage Vpos_ref, and a second reference voltage Vneg_ref.

The sensing unit 100B may include a first circuit 101 and a second circuit 102. In embodiments, a first low pass filter 103 and a second low pass filter 104 may be connected to the second circuit 102.

The first circuit 101 according to an example embodiment may generate a glitch voltage Vglitch from a power supply voltage Vsupply.

To this end, the first circuit 101 may include a first resistor R1 and a first capacitor C1 connected in parallel between a first node N1, from which the glitch voltage Vglitch is output, and the power supply voltage Vsupply. Also, the first circuit 101 may include a second resistor R2 and a second capacitor C2 connected in parallel between the first node N1 and a ground.

The second circuit 102 according to an example embodiment may generate a second reference voltage Vneg_ref. To this end, the second circuit 102 may further include a fifth resistor R5 and a sixth resistor R6 connected in series between the power supply voltage Vsupply and the ground.

The sensing unit 100B may apply the second low pass filter 104 to a signal which is output from a third node N3 between a fifth resistor R5 and a sixth resistor R6, to generate a second reference voltage Vneg_ref A voltage level of the second reference voltage Vneg_ref may be determined based on resistance values of the fifth resistor R5 and the sixth resistor R6.

The glitch detector 10B may include a clock generator 200B configured to generate a first clock signal Vpos_clk and a second clock signal Vneg_clk. In some embodiments, one or more of the first clock signal Vpos_clk and the second clock signal Vneg_clk may correspond to the clock signal Vclk discussed above.

The clock generator 200B may generate a first clock signal Vpos_clk and a second clock signal Vneg_clk by receiving the power supply voltage Vsupply or the glitch voltage Vglitch.

According to an example embodiment, the clock generator 200B may include a first pulse generator (for example, the first pulse generator 201 of FIG. 3B) configured to generate the second clock signal Vneg_clk while a positive voltage change occurs in one of the power supply voltage Vsupply and the glitch voltage Vglitch.

Also, the clock generator 200B may include a second pulse generator 802 generating a second clock signal Vneg_clk while a negative voltage change occurs in one of the power supply voltage Vsupply and the glitch voltage Vglitch.

Referring to FIG. 8, the second pulse generator 802 included in the clock generator 200B may include PMOS transistors PT1, PT2, and PT3, a current source 307, NMOS transistors NT1 and NT2, a first inverter 308, a second inverter 809, monitoring resistors MR1 and MR2, and monitoring capacitors MC1 and MC2.

The second pulse generator 802 may output a signal, which may be obtained after the second sensing voltage Vneg_sen at the first clock node CN1 passes through the first inverter 308 and the second inverter 809, as a second pulse voltage Vneg_pulse.

The second pulse generator 802 illustrated in FIG. 8 may have substantially the same structure as the first pulse generator 201 illustrated in FIG. 3B. In addition, the second pulse generator 802 may further include a second inverter 809 connected in series with the first inverter 308.

According to an example embodiment, the first pulse generator 201 and the second pulse generator 802 may be implemented as a single component. For example, the clock generator 200B may output a signal, obtained after the first pulse voltage Vpos_pulse output from the first pulse generator 201 illustrated in FIG. 3B passes through the second inverter 809, as a second pulse voltage Vneg_pulse.

The clock generator 200B may continuously generate a plurality of pulse signals according to a predetermined period while the second pulse voltage Vneg_pulse is generated.

For example, the clock generator 200B may output the second clock signal Vneg_clk, including a plurality of pulse signals continuously generated according to the predetermined period, while the second pulse voltage Vneg_pulse is maintained.

Referring to FIG. 9, the clock generator 200B according to an example embodiment may generate a first clock signal Vpos_clk and a second clock signal Vneg_clk while a voltage change occurs in the glitch voltage Vglitch (or the power supply voltage Vsupply).

Each of the first clock signal Vpos_clk and the second clock signal Vneg_clk may include a plurality of pulse signals generated according to a specified period while a voltage change occurs in one of the power supply voltage Vsupply and the glitch voltage Vglitch.

However, for example, each of the first clock signal Vpos_clk and the second clock signal Vneg_clk may be generated after a delay time (for example, t1 of FIG. 3C), at which a constant voltage change occurs, has passed since a voltage change occurred in one of the power supply voltage Vsupply and the glitch voltage Vglitch.

The glitch detector 10B may include a comparison unit 300B configured to determine whether a glitch has occurred in response to the clock signals Vpos_clk and Vneg_clk.

The comparison unit 300B may include a first comparator 301 configured to compare the glitch voltage Vglitch with a first reference voltage Vpos_ref in response to the first clock signal Vpos_clk generated by the clock generator 200B. Also, the comparison unit 300B may include a second comparator 302 configured to compare the glitch voltage Vglitch with the second reference voltage Vneg_ref in response to the second clock signal Vneg_clk generated by the clock generator 200B.

For example, referring to FIGS. 7 and 9 together, the second comparator 302 may compare the glitch voltage Vglitch and the second reference voltage Vneg_ref in response to each of the plurality of pulse signals, included in the second clock signal Vneg_clk, being input.

For example, the second comparator 302 may output a second detection voltage Vneg_det when the glitch voltage Vglitch is less than the second reference voltage Vneg_ref.

In this way, the glitch detector 10B may determine that a glitch (for example, a down-glitch) has occurred in the power supply voltage Vsupply.

As described above, the second comparator 302 may not operate in a state in which the second clock signal Vneg_clk is not input.

In this way, the glitch detector 10B may significantly reduce power consumed by the comparison unit 300B during a normal operation in which a voltage change (or a glitch) does not occur in the power supply voltage Vsupply.

In addition, the glitch detector 10B may determine whether a glitch has occurred in response to a clock signal including a plurality of pulse signals continuously generated while a voltage change occurs in the power supply voltage Vsupply.

In this way, the glitch detector 10B may detect whether a glitch has occurred in the power supply voltage Vsupply without being affected by a glitch occurrence speed, a glitch occurrence period, and/or a glitch pulse width.

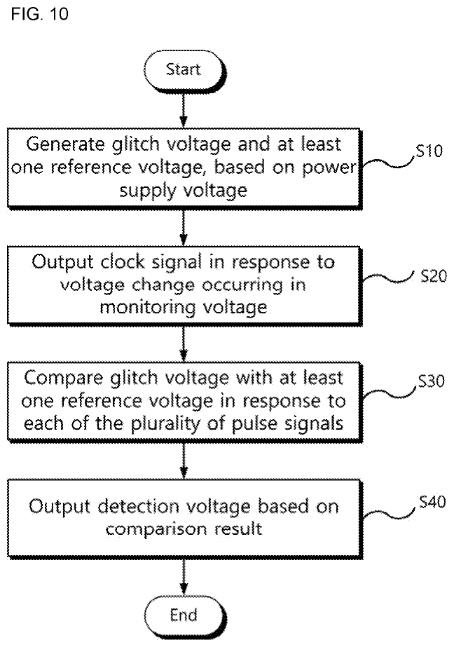

FIG. 10 is a flowchart illustrating a glitch detection method according to an example embodiment.

Referring to FIGS. 1 and 10 together, the glitch detector 10 according to an example embodiment may determine whether a glitch has occurred in the power supply voltage Vsupply, in response to a clock signal generated while a voltage change occurs in the power supply voltage Vsupply.

In operation S10, a glitch voltage Vglitch and at least one reference voltage Vref may be generated based on a power supply voltage Vsupply.

For example, the glitch detector 10 may generate a glitch voltage Vglitch, corresponding to at least a portion of the power supply voltage Vsupply, and at least one reference voltage Vref using the sensing unit 100.

The glitch detector 10 may apply at least one filter to the power supply voltage Vsupply to generate at least one reference voltage Vref.

In operation S20, the glitch detector 10 may output a clock signal Vclk in response to a voltage change occurring in the monitoring voltage Vmon.

For example, the glitch detector 10 may output the clock signal Vclk including a plurality of pulse signals using the clock generator 200 in response to the voltage change occurring in the monitoring voltage Vmon corresponding to the power supply voltage Vsupply or the glitch voltage Vglitch.

For example, the glitch detector 10 may generate a plurality of pulse signals according to a predetermined period using the clock generator 200 while a voltage change occurs in the monitoring voltage Vmon.

In operation S30, the glitch detector 10 may compare the glitch voltage Vglitch with at least one reference voltage Vref in response to each of the plurality of pulse signals.

For example, the glitch detector 10 may compare the glitch voltage Vglitch with the at least one reference voltage Vref through the comparison unit 300 operating in response to each of the plurality of pulse signals included in the clock signal Vclk.

For example, the glitch detector 10 may compare the glitch voltage Vglitch with the first reference voltage Vpos_ref through the first comparator 301 operating in response to the first clock signal Vpos_clk.

In operation S40, the glitch detector 10 may output a detection voltage Vdet based on a result of the comparison.

For example, the glitch detector 10 may output the detection voltage Vdet based on the result of the comparison of the comparison unit 300 when determining that a glitch has occurred in the power supply voltage Vsupply (or the glitch voltage Vglitch).

As an example, the glitch detector 10 may determine that an up-glitch has occurred, when the glitch voltage Vglitch is greater than the first reference voltage Vpos_ref. Accordingly, the glitch detector 10 may output the first detection voltage Vpos_det through the first comparator 301.

As another example, the glitch detector 10 may determine that a down-glitch has occurred, when the glitch voltage Vglitch is less than the second reference voltage Vneg_ref. Accordingly, the glitch detector 10 may generate the second detection voltage Vneg_det through the second comparator 302.

As described above, the glitch detector 10 may continuously detect whether a glitch has occurred in the power supply voltage Vsupply, in response to each of a plurality of pulse signals continuously generated while a voltage change occurs in the power supply voltage Vsupply.

In this way, the glitch detector 10 may detect whether a glitch has occurred without being affected by a glitch occurrence rate, a glitch occurrence period, and/or a glitch pulse width.

As described above, the comparison unit 300 included in the glitch detector 10 may not operate in a state in which the clock signal Vclk is not input.

In this way, the glitch detector 10 may significantly reduce power consumed by the comparison unit 300 during a normal operation in which a voltage change (or a glitch) does not occur in the power supply voltage Vsupply.

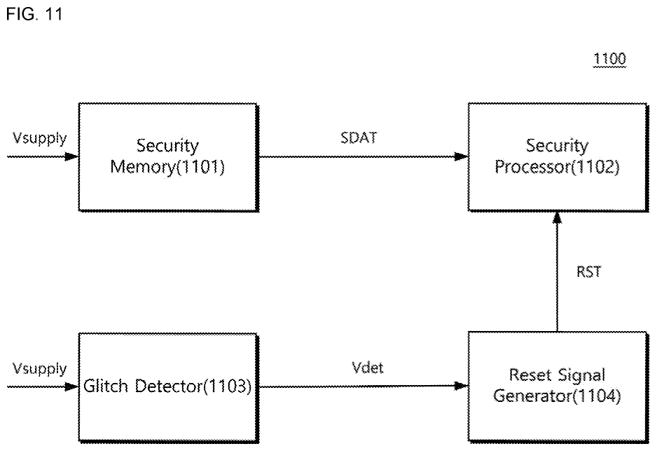

FIG. 11 is a block diagram illustrating a security device according to an example embodiment.

Referring to FIG. 11, a security device 1100 may include a security memory 1101, a security processor 1200, a glitch detector 1300, and a reset signal generator 1400.

For example, the security device 1100 may be referred to as a smart card or a SE (security element), but example embodiments are not limited thereto.

The security memory 1101 may store secure data SDAT. The security processor 1102 may process the secure data SDAT.

For example, the secure data SDAT may include a cryptographic key, sensitive data, and a sensitive code.

For example, the security memory 1101 and the security processor 1102 may operate based on a power supply voltage Vsupply.

According to an example embodiment, the security memory 1101 may include a nonvolatile memory such as an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), or the like, and/or a volatile memory such as a dynamic random access memory (DRAM), a static random access memory (SRAM), or the like.

According to an example embodiment, the security processor 1102 may include any control device such as a central processing unit (CPU), a microprocessor, or the like.

According to an example embodiment, the security device 1100 may have a tamper-resistant function to be protected from a tampering attack such as microprobing, a software attack, eavesdropping, fault injection, or the like.

A microprobing technique may be used to directly access a chip surface. A software attack technique may use a communication interface of a processor and exploit security vulnerability arising from a protocol, a cryptographic algorithm, or an algorithm execution. An eavesdropping technique may measure analog characteristics of all supply and interface connections and any other electromagnetic radiation produced by a processor during a normal operation. A fault injection technique may generate malfunctions in a processor, providing an additional access, using abnormal environment conditions.

The microprobing technique may be an invasive attack technique, and may require a relatively large amount of time. The other techniques discussed above may be noninvasive attacks.

As a noninvasive attach technique, a glitch attack technique may relate to hacking the security device 1100 by applying an abnormal signal to a power signal or an externally provided signal, which may cause the security device 1100 to operate unpredictably.

For example, a method of leaking secure data SDAT from the security memory 1101 by applying a glitch to a voltage (for example, a power supply voltage Vsupply) for driving an internal component of the security device 1100 may be attempted.

The glitch detector 1103 may output at least one detection voltage Vdet when a glitch occurs in the power supply voltage Vsupply. The glitch detector 1103 may be a glitch detector according to example embodiments, and may be implemented as described above with reference to FIGS. 1 to 10.

The glitch detector 1103 may generate a clock signal Vclk while a glitch occurs, and perform a comparison operation based on the generated clock signal Vclk. Accordingly, constant current and power consumption of the glitch detector 1103 may be reduced during a normal operation in which a glitch does not occur.

Also, the glitch detector 1103 may detect a glitch in response to each of a plurality of pulse signals generated according to a predetermined period while the glitch occurs. Accordingly, the glitch detector 1103 may detect a glitch without being affected by a glitch occurrence speed, a glitch occurrence period, and/or a glitch pulse width.

The reset signal generator 1104 may generate a reset signal RST based on at least one detection voltage Vdet. For example, a waveform of the reset signal RST may be substantially the same as a waveform of at least one of the first detection voltage Vpos_det and the second detection voltage Vneg_det.

The reset signal RST may be provided to the security processor 1102. The security processor 1102 may be reset based on a reset signal RST. Accordingly, the security device 1100 may protect the secure data SDAT from leakage, destruction, or tempering of the secure data SDAT caused by an external attack. In this way, the security performance of the security device 1100 may be improved.

In FIG. 11, the reset signal RST is illustrated as being provided only to the security processor 1102, but example embodiments may not be limited thereto. For example, the reset signal RST may also be provided to the security memory 1101, and the security memory 1100 may also be reset based on the reset signal RST.

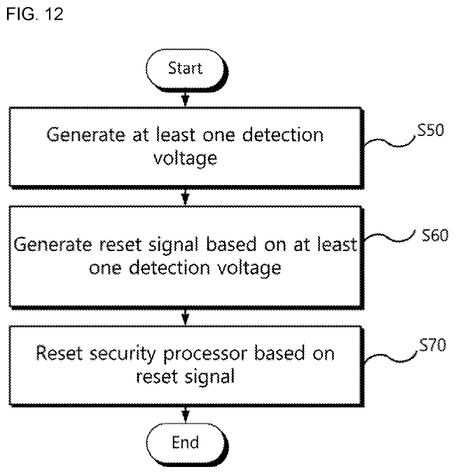

FIG. 12 is a flowchart illustrating a method of operating the security device of FIG. 11.

Referring to FIGS. 11 and 12 together, the security device 1100 may reset the security processor 1102 through the reset signal RST in response to the detection voltage Vdet output as a glitch occurs.

In operation S50, the security device 1100 may generate at least one detection voltage.

For example, the security device 1100 may generate at least one detection voltage Vdet when determining that a glitch has occurred in the power supply voltage Vsupply. Operation S50 may be performed based on the glitch detection method through operation S10 to S40 of FIG. 10.

In operation S60, the security device 1100 may generate a reset signal RST based on the at least one detection voltage Vdet.

For example, the security device 1100 may generate the reset signal RST through the reset signal generator 1104 in response to the at least one detection voltage Vdet being output from the glitch detector 1103.

For example, the reset signal generator 1104 generates a reset signal RST, having a waveform corresponding to a waveform of the at least one detection voltage Vdet, in response to reception of the at least one detection voltage Vdet from the glitch detector 1103.

In operation S70, the security device 1100 may reset the security processor 1102 based on the reset signal RST.

According to an example embodiment, the security memory 1101 may also be reset based on the reset signal RST.

According to the above-described configurations, the security device 1100 may detect a security attack, including a glitch attack, to reset the security processor 1102 and/or the security memory 1101. In this way, the security device 1100 may protect an electronic device and/or an electronic system, including the security device 1100, from external security attacks.

In embodiments, at least one of the security device 1100, the glitch detector 1103, and the glitch detection method according to example embodiments may be implemented as a product having computer readable program code. The computer readable program code may be provided to a processor of a general-purpose computer, a specific-purpose computer, or other programmable data processing apparatus. The computer readable medium may be a computer readable signal medium or a computer readable storage medium. The computer readable storage medium may be any tangible medium that can contain or store a program for use by or in connection with an instruction execution system, apparatus, or device. For example, the computer readable medium may be provided in the form of a non-transitory computer readable medium. The term “non-transitory” only means that the storage media is tangible without including a signal, regardless of whether data is semi-permanently or transitorily stored in the storage media.

As described above, the glitch detector 10 according to an example embodiment may determine whether a glitch has occurred in a power supply voltage Vsupply, in response to a plurality of pulse signals continuously generated while a voltage change (or a glitch) occurs in the power supply voltage Vsupply.

In this way, the glitch detector 10 may detect whether a glitch has occurred without being affected by a glitch occurrence speed, a glitch occurrence period, and/or a glitch pulse width.

According to an example embodiment, the comparison unit 300 included in the glitch detector 10 may operate in response to each of the plurality of pulse signals included in the clock signal Vclk. For example, the comparison unit 300 included in the glitch detector 10 may not operate in a state in which the clock signal Vclk is not input.

In this way, the glitch detector 10 may significantly reduce power consumed by the comparison unit 300 during a normal operation in which a voltage change (or a glitch) does not occur in the power supply voltage Vsupply.

As set forth above, a glitch detector according to example embodiments may continuously generate clock signals while glitches occur in a power supply voltage, and thus may detect the glitches without being affected by characteristics of the glitches.

While example embodiments have been shown and described above, it will be apparent to those skilled in the art that modifications and variations could be made without departing from the scope of the present disclosure as defined by the appended claims.

What is claimed is:

1. A glitch detector comprising:
a sensing unit configured to generate a glitch voltage and at least one reference voltage based on a power supply voltage;
a clock generator configured to receive a monitoring voltage corresponding to at least one from among the power supply voltage and the glitch voltage, and to output a clock signal comprising a plurality of pulse signals while a voltage change occurs in the monitoring voltage, wherein the plurality of pulse signals have a predetermined period; and
a comparison unit configured to operate based on each of the plurality of pulse signals, and to compare the glitch voltage with the at least one reference voltage and output a detection voltage based on determining that a glitch has occurred.

2. The glitch detector of claim 1, wherein the clock generator comprises:
a pulse generator configured to generate a pulse voltage while the voltage change occurs; and
an oscillator configured to generate the plurality of pulse signals having the predetermined period while the generated pulse voltage is maintained.

3. The glitch detector of claim 2, wherein the oscillator is further configured to:
receive external clock signals having the predetermined period from an external clock generator; and
while the pulse voltage is maintained, output the external clock signals as the clock signal.

4. The glitch detector of claim 1, wherein the comparison unit comprises:
a first comparator configured to determine that an up-glitch has occurred based on the glitch voltage being greater than a first reference voltage from among the at least one reference voltage, and to output a first detection voltage; and
a second comparator configured to determine that a down-glitch has occurred based on the glitch voltage being less than a second reference voltage from among the at least one reference voltage, and to output a second detection voltage, wherein the second reference voltage is lower than the first reference voltage.

5. The glitch detector of claim 4, wherein the sensing unit comprises:
a first circuit configured to generate the glitch voltage based on the power supply voltage; and
a second circuit configured to generate the at least one reference voltage based on the power supply voltage.

6. The glitch detector of claim 5, wherein the first circuit comprises:
a first resistor connected in parallel with a first capacitor between a first node and a power supply voltage node corresponding to the power supply voltage, wherein the glitch voltage is output from the first node; and
a second resistor connected in parallel with a second capacitor between the first node and a ground node.

7. The glitch detector of claim 6, wherein the second circuit comprises a third resistor and a fourth resistor connected in series between the power supply voltage node and the ground node, and
wherein the sensing unit is further configured to generate the first reference voltage by applying a first low pass filter to a signal output from a second node connected to the third resistor and the fourth resistor.

8. The glitch detector of claim 7,
wherein the second circuit further comprises:
a fifth resistor connected between the power supply voltage node and a third node; and
a sixth resistor connected between the third node and the ground node, and
wherein the sensing unit is further configured to generate the second reference voltage by applying a second low pass filter to a signal output from the third node.

9. The glitch detector of claim 2, wherein the pulse generator comprises:
a first P-type metal oxide semiconductor (PMOS) transistor connected to a first clock node from which a first sensing voltage is output based on the voltage change of the monitoring voltage;
a first N-type metal oxide semiconductor (NMOS) transistor connected between the first clock node and a ground node;
a second NMOS transistor connected between a second clock node and the ground node wherein a gate electrode of the second NMOS transistor is connected to the second clock node;
a first monitoring resistor connected between the second clock node and a gate electrode of the first NMOS transistor;
a second monitoring resistor connected to a gate electrode of the first PMOS transistor;
a first monitoring capacitor connected between a monitoring voltage node corresponding to the monitoring voltage and the gate electrode of the first NMOS transistor; and
a second monitoring capacitor connected between the monitoring voltage node and the gate electrode of the first PMOS transistor.

10. The glitch detector of claim 9, wherein the pulse generator is configured to activate the second NMOS transistor and deactivate the first PMOS transistor in response to the voltage change occurring in the monitoring voltage.

11. A glitch detection method comprising:
generating, using a sensing unit, a glitch voltage and at least one reference voltage based on a power supply voltage;
outputting, using a clock generator, a clock signal comprising a plurality of pulse signals while a voltage change occurs in a monitoring voltage corresponding to at least one from among the power supply voltage or the glitch voltage, wherein the plurality of pulse signals have a predetermined period;
comparing, suing a comparison unit, the glitch voltage with the at least one reference voltage based on each of the plurality of pulse signals; and
outputting a detection voltage based on determining that a glitch has occurred in the power supply voltage, based on a result of the comparison.

12. The glitch detection method of claim 11, wherein the outputting the clock signal further comprises:
generating a pulse voltage while the voltage change occurs; and
outputting the plurality of pulse signals having the predetermined period while the generated pulse voltage is maintained.

13. The glitch detection method of claim 12, wherein the outputting the clock signal comprises:
receiving external clock signals having the predetermined period from an external clock generator; and
while the pulse voltage is maintained outputting the external clock signals received from the external clock generator as the plurality of pulse signals.

14. The glitch detection method of claim 12,
wherein the clock generator comprises:
a first P-type metal oxide semiconductor (PMOS) transistor connected between a first clock node, from which the pulse voltage is output, and a power supply voltage node corresponding to the power supply voltage; and
a first N-type metal oxide semiconductor (NMOS) transistor connected between the first clock node and a ground node, and
wherein the generating the pulse voltage comprises activating the first NMOS transistor and deactivating the first PMOS transistor in response to the voltage change.

15. The glitch detection method of claim 11, wherein the outputting the detection voltage comprises:
determining that an up-glitch has occurred based on the glitch voltage being greater than a first reference voltage from among the at least one reference voltage, and outputting a first detection voltage; and
determining that a down-glitch has occurred based on the glitch voltage being less than a second reference voltage from among the at least one reference voltage, and outputting a second detection voltage, wherein the second reference voltage is lower than the first reference voltage.

16. A security device comprising:
a security memory configured to store secure data;
a security processor configured to process the secure data and reset based on a reset signal;
a glitch detector configured to generate at least one detection voltage in response to a glitch occurring in a power supply voltage; and
a reset signal generator configured to generate the reset signal based on the at least one detection voltage,
wherein the glitch detector comprises:
a sensing unit configured to generate a glitch voltage and at least one reference voltage based on the power supply voltage;
a clock generator configured to receive a monitoring voltage corresponding to at least one from among the power supply voltage and the glitch voltage, and to output a clock signal comprising a plurality of pulse signals while a voltage change occurs in the monitoring voltage, wherein the plurality of pulse signals have a predetermined period; and
a comparison unit configured to operate based on each of the plurality of pulse signals and to compare the glitch voltage with the at least one reference voltage and output a detection voltage based on determining that the glitch has occurred.

17. The security device of claim 16, wherein the clock generator comprises:
a pulse generator configured to generate a pulse voltage while the voltage change occurs; and
a clock generation circuit configured to output the plurality of pulse signals having the predetermined period while the generated pulse voltage is maintained

18. The security device of claim 17, wherein the clock generation circuit configured to:
receive external clock signals, generated according to the predetermined period, from an external clock generator; and
output external clock signals received while the pulse voltage is maintained, among the external clock signals received from the external clock generator, as the clock signal.

19. The security device of claim 17,
wherein the pulse generator comprises:
a first P-type metal oxide semiconductor (PMOS) transistor connected between a first clock node, from which the pulse voltage is output, and a power supply voltage node corresponding to the power supply voltage; and
a first N-type metal oxide semiconductor (NMOS) transistor connected between the first clock node and a ground node, and
wherein the pulse generator is configured to activate the first NMOS transistor and to deactivate the first PMOS transistor based on the voltage change.

20. The security device of claim 16, wherein the comparison unit comprises:
a first comparator configured to determine that an up-glitch has occurred based on the glitch voltage being greater than a first reference voltage from among the at least one reference voltage, and to output a first detection voltage; and
a second comparator configured to determine that a down-glitch has occurred based on the glitch voltage being less than a second reference voltage from among the at least one reference voltage, and to output a second detection voltage, wherein the second reference voltage is lower than the first reference voltage.
